(19) United States
(12) Patent Application Publication
(10) Pub. No.: US 2006/0104081 A1
(43) Pub. Date: May 18, 2006

(54) Lighting system

(76) Inventor: Hadrian Nicholas Fraval, Dingley (AU)

Correspondence Address: KENNETH M. FAGIN, 136 SUMMER WALK DRIVE, GAITHERSBURG, MD, 20878, US

(21) Appl. No.: 10/527,701

(22) PCT Filed: Sep. 12, 2003
(86) PCT No.: PCT/AU03/01197

§ 371 Date: Apr. 26, 2005

(30) Foreign Application Priority Data
Sep. 13, 2002 (AU) 2002951376

(51) Int. Cl. F21V 7/04; G02B 17/00; G02B 21/00

(52) U.S. Cl. 362/557

(57) ABSTRACT

A lighting system for a building having rooms (35) is disclosed which includes a plurality of light collectors (12, 14) for collecting ambient light, and a plurality of light guides (16) for conveying the light to a light accumulating vessel (20). The vessel (20) has an internal reflective surface (21). A plurality of second light guides (35) extend from the vessel (20) to the rooms (35) so that light which is collected in the vessel and which reflects in the vessel eventually finds it way to the light guides (34) supply to the rooms (35) to illuminate the rooms.

### FIELD OF THE INVENTION

This invention relates to a lighting system for lighting rooms of a building, dwelling, or the like (collectively referred to as a building herein).

### BACKGROUND ART

Conventional lighting systems comprise fixed or free-standing lights which are located in rooms of a building. The lights are connected to a source of electricity and are turned on and off by a switch which is electrically connected by wires to the lights and to the source of electricity. This form of lighting is of course well known and conventionally used throughout the world.

Conventional lighting systems of this type require the generation electricity and subsequent infrastructure as well as hard wiring in the building. Whilst the electricity generation facility infrastructure is also required to supply electricity to buildings for other purposes, there is obviously a saving in energy to be made if at least part of the lighting requirements for a building can be produced without the need of energy generation.

Of course, some of the lighting required by a building can be provided by natural light which enters through windows. However, depending on the nature of the building and the location of rooms within the building, usually natural light is not sufficient to sufficient illumination to adequately light the rooms of the building. Furthermore, the obviously the use of natural light which merely is provided by way of a window requires the windows to be uncovered which, in many environments, is not desirable.

### SUMMARY OF THE INVENTION

The object of the invention is to provide a lighting system which can provide at least part of the lighting for a building without the need to rely on electric power.

The first aspect of the invention provides a light system for a building, including:
at least one light collector for collecting ambient light; and
a light guide for conveying light from the collector to a room of a building.

Thus, by collecting ambient light and conveying the collected light to a building by a light guide, at least some of the lighting requirements for the building is provided by the collected ambient light, and therefore the need for electrically powered lights is at least reduced.

In one embodiment of the invention the system further includes light junction member, and the light guide comprises a first light guide extending between the collector and the junction member, and a second light guide extending from the junction member to the room of the building.

In one embodiment of the invention the light collector comprises a dish reflector for reflecting ambient light towards a focal point, a secondary reflector at the focal point for reflecting light into the first light guide.

In one embodiment of the invention a plurality of said light collectors are provided, each collector being connected to the junction member by a respective first light guide.

In one embodiment of the invention a plurality of said second light guides extend from the light junction member for conveying light from the junction member to the at least one room of the building.

In one embodiment of the invention a plurality of rooms of the building are illuminated by the lighting system and a plurality of second light guides extend from the light junction member to each room of the building.

In one embodiment of the invention the junction means comprises a vessel having a highly reflective inner surface so that light which is conveyed into the vessel by the first light guides reflects within the vessel until the light enters one of the seconde waveguides and is conveyed to the room to illuminate the room.

In one embodiment of the invention the vessel is spherical and lined with a good reflective material such as halon, reflective paint, etc.

In one embodiment of the invention the vessel includes intensity sensors for monitoring the intensity of prescribed wavelengths of light within the vessel, and control means responsive to the energy sensor for controlling at least one light source for supplying light into the vessel to maintain the light in the vessel as substantially white light so that white light is supplied to the rooms by the second waveguides.

The invention in a further aspect may be said to reside in a lighting system for a building having a plurality of rooms, including:
a plurality of light collectors for collecting ambient light, each collector comprising a reflector for reflecting light towards a point;
a light guide having a first end located at the point for receiving light from the reflect;
a light accumulating vessel having a reflective internal surface, the vessel being connected to each of the light guides so that light reflected into the light guides is conveyed to the vessel and propagates within the vessel by reflection from the internal surface of the vessel; and
a plurality of second light guides extending from the vessel to rooms of the building for conveying light from the vessel to the rooms of the building to illuminate the rooms.

In one embodiment of the invention the reflector includes a parabolic dish-shaped reflector and the focal point is the focal point of the parabolic reflector at which the end of the first light guide is located. However, in the preferred embodiment, the collector further includes a concave focusing mirror at the focal point of the parabolic reflector for reflecting the light to a further point at which the first end of the first light guide is located for conveying the light to the vessel.

In one embodiment of the invention the vessel includes a plurality of intensity sensors for measuring the intensity of light within the vessel at various wavelengths, control means connected to the intensity sensor, a light source for supplying light into the vessel connected to the control means so that the control means can control the light source to provide illumination into the vessel for maintaining the light within the vessel substantially as white light so that white light is conveyed by the second waveguides to the rooms of the building.

The light source may be a fixed light source connected to the vessel or may be a light source remote from the vessel and coupled to the vessel by a light guide.

The invention may also be said to reside in a lighting system for a building having a plurality of rooms, including:
a plurality of light collectors for collecting ambient light, each collector comprising a dish reflector for reflecting light towards a focal point and a secondary reflector at the focal point;
a light guide associated with each of the collectors for receiving light reflected by the secondary reflector;
a light accumulating vessel having a reflective internal surface, the vessel being connected to each of the light guides so that light reflected into the light guides from the secondary reflectors is conveyed to the vessel and propagates within the vessel by reflection from the internal surface of the vessel; and
a plurality of second light guides extending from the vessel to rooms of the building for conveying light from the vessel to the rooms of the building to illuminate the rooms.

In one embodiment of the invention the vessel includes a plurality of intensity sensors for measuring the intensity of light within the vessel at various wavelengths, control means connected to the intensity sensor, a light source for supplying light into the vessel connected to the control means so that the control means can control the light source to provide illumination into the vessel for maintaining the light within the vessel substantially as white light so that white light is conveyed by the second waveguides to the rooms of the building.

The light source may be a fixed light source connected to the vessel or may be a light source remote from the vessel and coupled to the vessel by a light guide.

In one embodiment of the invention the dish reflectors and the secondary reflectors reflect white light to their respective waveguides so that wavelengths outside the normal visible spectrum are not supplied to the vessel.

In one embodiment infrared radiation may be reflected to an ancillary light guide or otherwise collected so that the infrared radiation can be used as a heat source to provide supplemental heating to the building or for water heating.

### BRIEF DESCRIPTION OF THE DRAWINGS

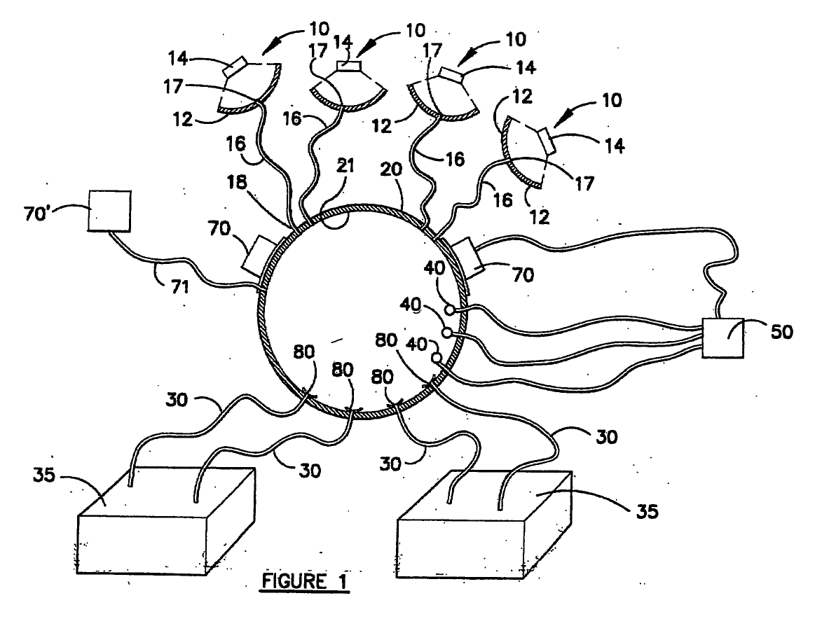

One embodiment of the invention will be described, by way of example, with reference to the accompanying FIG. 1 which shows a preferred embodiment of the invention.

### DETAILED DESCRIPTION OF THE EMBODIMENT

With reference to FIG. 1, a lighting system according to one embodiment is shown. The lighting system comprises a plurality of ambient light collectors 10 which may be mounted on a roof of a building, or in close proximity to a building. Each collector 10 comprises a parabolic dish reflector 12 and a concave focusing mirror 14. The mirror 14 is arranged at the focal point of the parabolic reflector 12 so that ambient light which is reflected by the reflectors 12 is reflected by the mirrors 14 to a respective waveguide 16. The waveguide 16 has a first end 17 projecting through the dish reflector 12 and located at a point for receipt of the light reflected by the mirror 14. Other end 18 of the light guide 16 is connected to a spherical vessel 20 which acts as a junction vessel for collecting light conveyed by the light guides 16. The vessel 20 has an internal surface 21 which is highly reflective so that light is simply propagated within the vessel by reflecting about the vessel without any absorption so there is substantially no loss of light within the vessel 20 and no heating of the vessel 20.

A plurality of second light guides 30 extend from the vessel 20 to rooms 35 of a building so that light is conveyed from the vessel to the rooms to illuminate the rooms. In the embodiment shown, each room has two light guides for supplying illumination, but more light guides could be provided, depending on the size of the room and the illumination which is required.

The vessel 30 also has a plurality of sensors 40 for sensing the intensity of electromagnetic radiation in the vessel of various wavelengths. For example, one of the sensors 40 could sense wavelengths near the infrared region of the spectrum, one intensity sensor 40 could measure the intensity of wavelengths in the middle of the visible spectrum, such as green light, and one of the sensors could measure the intensity of radiation towards the ultraviolet end of the spectrum. The sensors provide an intensity measure of the various wavelengths which therefore provides an indication of the light within the vessel and whether the light is substantially white light which is required for illumination. Depending on the length of the waveguides 16 and the ambient light conditions, the light which is conveyed by the light guide 16 to the vessel may be predominantly of a particular wavelength or range of wavelengths more than others, meaning the light may be slightly coloured or, alternatively, losses of particular wavelengths within the waveguide can result in the light being slightly coloured or closer to the infrared end of the spectrum, rather than evenly distributed throughout the visible spectrum.

In order to compensate for the loss of any wavelengths, the intensity sensors 40 are connected to a control system 50 which in turn is connected to one or more white light sources 70. In the embodiment shown, two light sources 70 are coupled to the sphere and are controlled by the control means to provide illumination into the vessel to compensate for any loss of a particular wavelength so that the light within the vessel is substantially white light, and therefore substantially white light is delivered to the rooms for illuminating the rooms.

Rather than provide the white light sources 70 on the vessel as shown, the light sources 70 could be coupled to the vessel by a waveguide 71 as illustrated by the light source labelled 70′ in the drawing.

The light source 70 is electrically powered light and therefore some electrically generated energy is required in order to be supplied to the vessel. However, a significant amount of the illumination is provided by the collectors 10 and therefore the overall illumination which is supplied to the rooms 35 is predominantly illumination which is collected by the collectors 10, thereby greatly reducing the reliance on electricity consumption for supply of illumination. Alternatively, an array of L.E.Ds could be connected to the vessel 20 to augment the light collected by the system. These L.E.Ds could be powered by a photo voltaic array and battery storage.

In order to supply illumination via the collectors 10 and the waveguides 16, the ambient conditions require daylight conditions and preferably clear sky. If there is significant cloud coverage, the amount of illumination will greatly decrease in the visible range of the spectrum, although infrared radiation probably will remain the same. Thus, the supply of white light by the sensors 70 is required. Furthermore, at night time, obviously no light will be collected by the collectors 10 and the light sources 70 are required to supply light into the vessel 20 which can then be conveyed by the light guides 30 to the rooms 35 if illumination is required at night.

In embodiment of the invention a single light source 70 is provided which is in the form of a fusion light which is comprised of a gas-filled envelope in which a bead of sulphur is contained. The envelope has a stem which is arranged in a magnetometer so that when the magnetometer is powered, microwave energy causes extremely intense illumination to be supplied. Such light sources are know, and therefore need not be described in any detail hereinafter. However, it is envisaged that a single light source of this type could supply sufficient illumination to the vessel 20 to provide lighting for a reasonably sized building during darkness.

In the preferred embodiment of the invention, each of the light guides 30 is provided with a shutter 80 which is arranged on the inside of the vessel 20 and has a contour which matches the curved contour of the inner side of the vessel 20. The shutter is arranged for movement relative to the end of the light guide 30 in the vessel so that the end of the light guides 30 can be shut off if needed so that illumination is prevented from entering the waveguides so that the lights of the rooms 35 can effectively be switched off if needed or desired.

The shutters 80 are preferably controlled by a remote control device which can be located in the room and simply actuated by a user to supply a signal to a detector in the room which in turn conveys a signal to a shutter mechanism for closing the shutters 80 or opening the shutters 80 as the case required.

Preferably the light guides 16 and 30 are light guides made according to our assigned International Patent Application PCT/US99/18228 (WO00/10044), the contents of which is incorporated into this specification by this reference. The light guide disclosed in this International application has the advantage of provided an extremely wide entrance aperture so that light at relatively high numerical apertures is able to enter the waveguides 16 from the mirror 14 and also enter the waveguides 30 from reflection within the vessel 20. Thus, when the shutters 80 are open and light is propagating within the vessel 20 by reflection from internal surface 21, the light will eventually find its way to the end of the light guide 30 and will enter the light guide 30 for propagation along the light guide 30 to the rooms 35 in the manner described above.

Since modifications within the spirit and scope of the invention may readily be effected by persons skilled within the art, it is to be understood that this invention is not limited to the particular embodiment described by way of example hereinabove.

1. A light system for a building, comprising:
at least one light collector for collecting ambient light; and
a light guide for conveying light from the collector to a room of a building.

2. The system of claim 1 wherein the system further includes a light junction member, and the light guide comprises a first light guide extending between the collector and the junction member, and a second light guide extending from the junction member to the room of the building.

3. The system of claim 1 wherein the light collector comprises a dish reflector for reflecting ambient light towards a focal point, a secondary reflector at the focal point for reflecting light into the first light guide.

4. The system of claim 1 wherein a plurality of said light collectors are provided, each collector being connected to the junction member by a respective first light guide.

5. The system of claim 2 wherein a plurality of said second light guides extend from the light junction member for conveying light from the junction member to the at least one room of the building.

6. The system of claim 2 wherein a plurality of rooms of the building are illuminated by the lighting system and a plurality of second light guides extend from the light junction member to each room of the building.

7. The system of claim 2 wherein the junction means comprises a vessel having a highly reflective inner surface so that light which is conveyed into the vessel by the first light guides reflects within the vessel until the light enters one of the seconde waveguides and is conveyed to the room to illuminate the room.

8. The system of claim 7 wherein the vessel is spherical and lined with a good reflective.

9. The system of claim 7 or 8 wherein the vessel includes intensity sensors for monitoring the intensity of prescribed wavelengths of light within the vessel, and control means responsive to the energy sensor for controlling at least one light source for supplying light into the vessel to maintain the light in the vessel as substantially white light so that white light is supplied to the rooms by the second waveguides.

10. A lighting system for a building having a plurality of rooms, including:
a plurality of light collectors for collecting ambient light, each collector comprising a reflector for reflecting light towards a point;
a light guide having a first end located at the point for receiving light from the reflect;
a light accumulating vessel having a reflective internal surface, the vessel being connected to each of the light guides so that light reflected into the light guides is conveyed to the vessel and propagates within the vessel by reflection from the internal surface of the vessel; and
a plurality of second light guides extending from the vessel to rooms of the building for conveying light from the vessel to the rooms of the building to illuminate the rooms.

11. The system of claim 10 wherein the reflector is a parabolic dish-shaped reflector and the focal point the focal point of the parabolic reflector at which the end of the first light guide is located.

12. They system of claim 10 wherein the reflector is a parabolic reflector and the collector further includes a concave focusing mirror at the focal point of the parabolic reflector for reflecting the light to a further point at which the first end of the first light guide is located for conveying the light to the vessel.

13. The system of claim 10 wherein the vessel includes a plurality of intensity sensors for measuring the intensity of light within the vessel at various wavelengths, control means connected to the intensity sensor, a light source for supplying light into the vessel connected to the control means so that the control means can control the light source to provide illumination into the vessel for maintaining the light within the vessel substantially as white light so that white light is conveyed by the second waveguides to the rooms of the building.

14. The system of claim 10 wherein the light source is a fixed light source connected to the vessel or a light source remote from the vessel and coupled to the vessel by a light guide.

15. A lighting system for a building having a plurality of rooms, including:
a plurality of light collectors for collecting ambient light, each collector comprising a dish reflector for reflecting light towards a focal point and a secondary reflector at the focal point;
a light guide associated with each of the collectors for receiving light reflected by the secondary reflector;
a light accumulating vessel having a reflective internal surface, the vessel being connected to each of the light guides so that light reflected into the light guides from the secondary reflectors is conveyed to the vessel and propagates within the vessel by reflection from the internal surface of the vessel; and
a plurality of second light guides extending from the vessel to rooms of the building for conveying light from the vessel to the rooms of the building to illuminate the rooms.

16. The system of claim 15 wherein the vessel includes a plurality of intensity sensors for measuring the intensity of light within the vessel at various wavelengths, control means connected to the intensity sensor, a light source for supplying light into the vessel connected to the control means so that the control means can control the light source to provide illumination into the vessel for maintaining the light within the vessel substantially as white light so that white light is conveyed by the second waveguides to the rooms of the building.

17. The system of claim 16 wherein the light source is a fixed light source connected to the vessel or a light source remote from the vessel and coupled to the vessel by a light guide.

18. The system of claim 15 wherein the dish reflectors and the secondary reflectors reflect white light to their respective waveguides so that wavelengths outside the normal visible spectrum are not supplied to the vessel.

19. The system of claim 16 wherein infrared radiation is reflected to an ancillary light guide or otherwise collected so that the infrared radiation can be used as a heat source to provide supplemental heating to the building or for water heating.
